(19) United States
(12) Patent Application Publication
(10) Pub. No.: US 2014/0195254 A1
(43) Pub. Date: Jul. 10, 2014

(54) Demand-driven blood bank enterprise planning and management system

(71) Applicant: Richard McElroy, Raleigh, NC (US)

(72) Inventor: Richard McElroy, Raleigh, NC (US)

(21) Appl. No.: 13/734,229

(22) Filed: Jan. 4, 2013

(51) Int. Cl. G06F 19/00

(52) U.S. Cl. CPC G06F 19/327
USPC 705/2

(57) ABSTRACT

A method for optimizing collection and usage of a necessary bodily fluid comprises determining an historical demand of the bodily fluid, measuring a first external contingent factor, creating a donor recruitment plan based at least in part on the historical demand and the external contingent factor, implementing the donor recruitment plan to recruit a number of donors, determining estimated units based at least in part on the number of donors and a second external contingent factor, collecting total units of the necessary bodily fluid, and calculating a variance between the total units and the estimated units to produce a real-time demand driven adjustment.

### BACKGROUND OF THE INVENTION

The present invention relates to demand-driven blood bank enterprise planning and management system.

Standard blood banking industry production control and supply chain management practices are inefficient and ineffective, constituted in evolved disparate practices that result in over-collection & wasted units. There is an evidenced inability in blood banks to collect blood on a demand-driven manner, to collect the right volume and type of blood at the right time reflective of patient transfusion needs. Standard practice is to collect as much blood as possible in an attempt to ensure that an adequate supply exists for patient care. This practice results in over-collection that, first, results in the expiration of unused blood in inventory that, second, results in biological waste disposal costs, third, that require significant labor and labor cost to collect the unused blood units, fourth, represents a volume and type of blood that frequently does not match the transfusion requirements and, fifth, jeopardizes the foundational psychological contract with the community, upon which rests the current philanthropic practice of donating blood. (Evidence suggests that occasionally too few, surgery-limiting units are collected, as reported by 5-10% of U.S. hospitals, similarly believed to be due to a lack of robust production control and supply chain management in blood banking which results in an inability in blood banks to collect blood on a demand-driven basis.) Recent data suggests that of the 17.3 million units annually collected in the United States, of which only 14.9 million units (or some 86% of total) are transfused, there are some 2.3 million units expiring before transfusion (i.e., expired or “outdated” units. In addition to the ethical issue of collecting and throwing away human blood, there is approximately $513 million in lost revenue, after incurring approximately $301.5 million in the cost of collection (and, of course, the additional cost of disposing this biological waste). For long-range and near-term shifting patient demand-driven blood transfusion supply, this invention integrates production control and supply chain management into a single enterprise-wide planning and management system, incorporating historical performance pattern recognition for strategic control across the blood bank operation.

### SUMMARY OF THE INVENTION

In one aspect of the present invention, a method for optimizing collection and usage of a necessary bodily fluid comprises: determining an historical demand of the bodily fluid; measuring a first external contingent factor; creating a donor recruitment plan based at least in part on the historical demand and the external contingent factor; implementing the donor recruitment plan to recruit a number of donors; determining estimated units based at least in part on the number of donors and a second external contingent factor; collecting total units of the necessary bodily fluid; and calculating a variance between the total units and the estimated units to produce a real-time demand driven adjustment.

In one aspect, the donor recruitment plan comprises a fixed site plan and the step of determining estimated units depends at least in part on the real-time demand driven adjustment. In one aspect, the donor recruitment plan comprises a mobile site plan and the step of determining estimated units depends at least in part on a donor show rate. In one aspect, the donor recruitment plan comprises a mobile site plan and the step of determining estimated units depends at least in part on a donor deferral rate. In one aspect, the first external contingent factor comprises a community economic development plan. In one aspect, the first external contingent factor comprises a community healthcare forecast. In one aspect, the first external contingent factor comprises a demographic study. In one aspect, the second external contingent factor comprises a donor walk-in historical profile by week day. In one aspect, the second external contingent factor comprises a donor show rate. In one aspect, the second external contingent factor comprises a donor deferral rate. In one aspect, the second external contingent factor comprises a collection loss. In one aspect, the second external contingent factor comprises a lab loss.

In another aspect of the present invention, a method for optimizing collection and usage of a necessary bodily fluid comprises: a) determining an historical demand of the bodily fluid; b) measuring a first external contingent factor; c) determining real-time changes to the historical demand; d) creating a fixed donor recruitment plan and a mobile donor recruitment plan based at least in part on the historical demand, the external contingent factor, and the real-time changes to the historical demand; e) implementing the fixed donor recruitment plan to recruit a fixed number of donors; f) determining estimated fixed units based at least in part on the fixed number of donors and a second external contingent factor; g) implementing the mobile donor recruitment plan to recruit a mobile number of donors; h) determining estimated mobile units based at least in part on the mobile number of donors and a third external contingent factor; i) collecting total units of the necessary bodily fluid; and j) calculating a variance between the total units, the estimated fixed units, and the estimated mobile units to produce a first real-time demand-driven adjustment.

In one aspect, the method further comprises the steps of: k) monitoring actual real-time demand; l) calculating a second variance between total units and the actual real-time demand to produce a second real-time demand-driven adjustment; and m) feeding back the first and second real-time demand-driven adjustments into step d) so that the step of creating in step d) depends at least in part on the first and second real-time demand-driven adjustments.

These and other features, aspects and advantages of the present invention will become better understood with reference to the following drawings, description and claims.

### BRIEF DESCRIPTION OF THE DRAWINGS

FIG. 1 shows a flowchart according to one embodiment of the present invention.

FIG. 2 shows a flowchart according to one embodiment of the present invention.

FIG. 3 shows a flowchart according to one embodiment of the present invention.

FIG. 4 shows a flowchart according to one embodiment of the present invention.

FIG. 5 shows a flowchart according to one embodiment of the present invention.

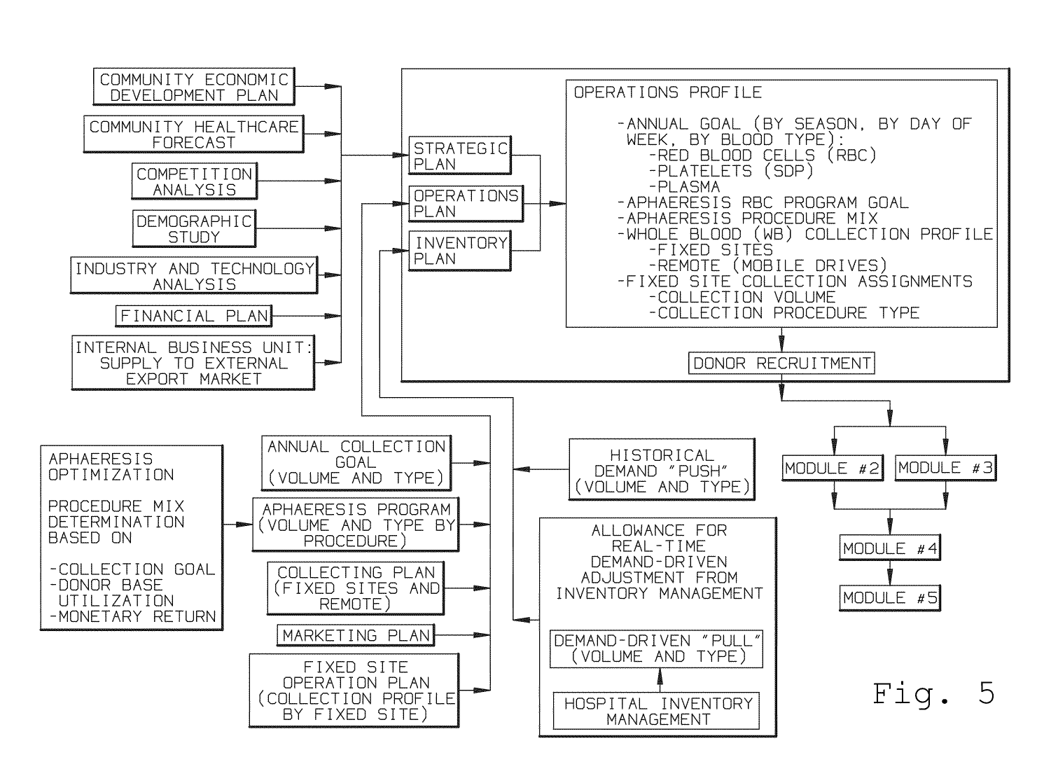

FIG. 6 shows a flowchart according to one embodiment of the present invention.

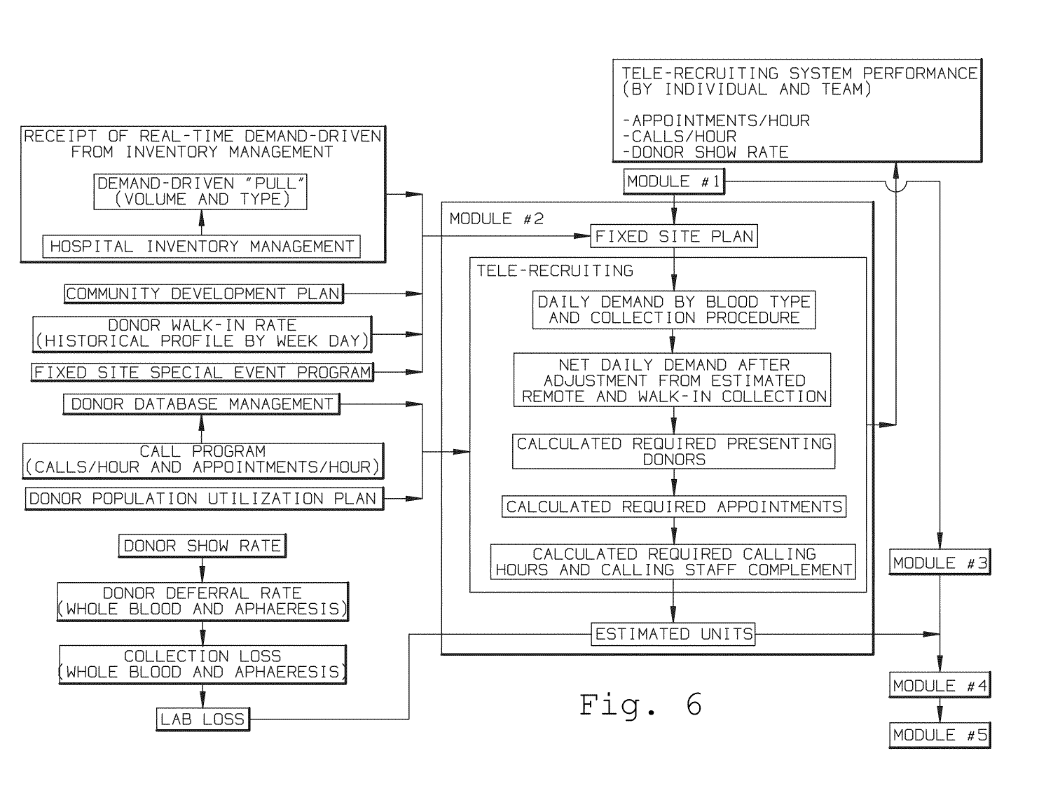

FIG. 7 shows a flowchart according to one embodiment of the present invention.

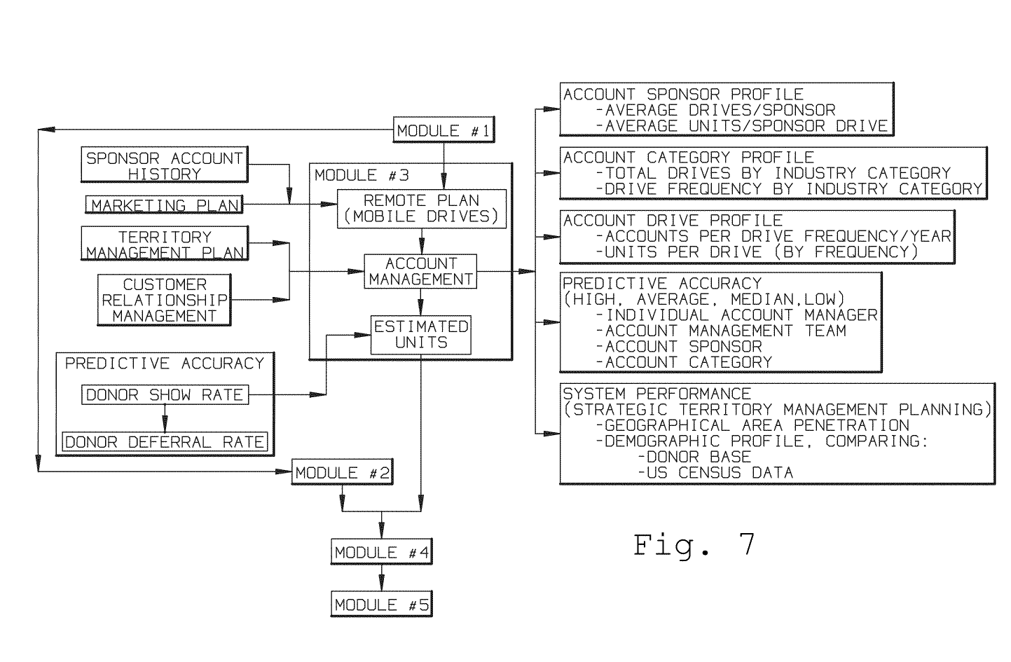

FIG. 8 shows a flowchart according to one embodiment of the present invention.

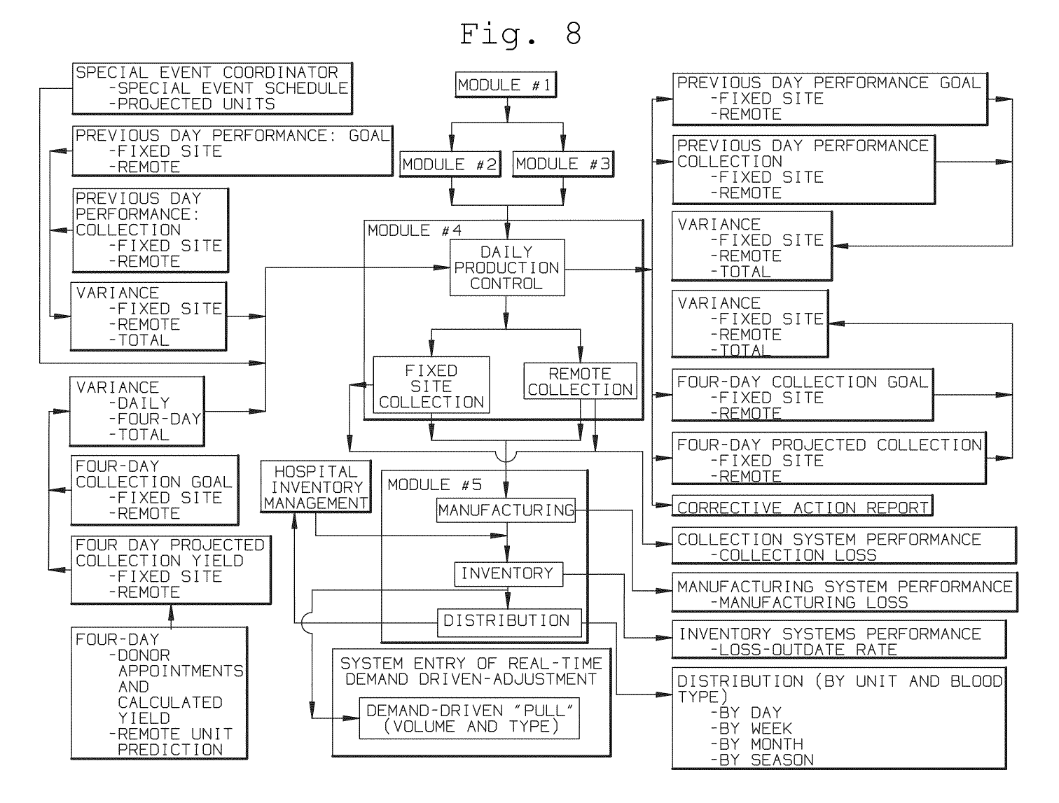

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Traditional industry practices: The linear approach to blood collection routinely yields either too many or too few blood units as determined by actual patient transfusion requirements.

Third-party point solutions: The third-party vendor independent “point solutions” first, do not provide an enterprise-wide holistic supply change solution. Second, they are not linked, resulting in independent solutions competing for the same enterprise resource (e.g., the same donor) and divorced from compensating coordination with other areas of enterprise performance.

The EPM System invention (the present invention) was designed as an enterprise-wide production control and supply chain management solution, linking and coordinating across the supply chain for an optimum collection solution to meet forecasted and dynamically shifting patient blood transfusion demand.

This invention “Demand-Driven Blood Bank Enterprise Planning and Management System” (EPM System) allows blood bank operations personnel to strategically plan for and operate in accordance with blood use demand (in the specific dimensions of volume, blood type and time) as reflected in the unique and innovative integration of, first, the historical demand/use performance pattern analysis and profile (i.e., Production Control “push” system) and, second, allowing for near-term dynamic shifts in demand, e.g., trauma, emergency surgery (i.e., Production Control “pull” system). This will allow collection of blood (in volume and type at a time dictated by patient transfusion requirements, the blood demand) and management of the blood across the supply chain (from blood donor recruitment to hospital blood inventory) with a higher probability of blood transfusion before expiration of the blood unit: the right volume, of the right type, at the right time.

This invention is an improvement on what currently exists. Current planning and management methods for blood collection fall within two categories: traditional industry practices and third-party point solutions.

Traditional industry practices: The traditional practice generally focuses on an annual volume demand (e.g., number of units distributed for transfusion in the previous year) with minimal consideration of blood type (e.g., O+, A−, AB) in planning donor recruitment and collection activities (especially for the mobile blood drive). This “raw” and coarse annual volume is often divided for operational collection planning into average unit need by month, week, or day (with inadequate analysis of and planning for the cyclical nature of blood demand, e.g., variance in blood use by season, month, week of the month, and day). The traditional system does not allow for dynamic shifts in demand other than on an “emergency” or “fire-fighting” manner (e.g., manual intervention into a static system).

Third-party point solutions: Various third-party vendors have developed “point solutions” that address specific planning and management functions within the blood supply change. These “solutions” center on discrete, isolatable functions within the supply chain and, then, are not designed or used for coordinating interaction.

EPM System Difference: The EPM System invention allows for planning and management congruency across the enterprise, ensuring adequate linkage, relationships, functionality, and solutions across the supply chain.

Both the traditional practice and the third-party solutions were not designed to address enterprise-wide production control and supply chain issues. In the case of evolving industry practices, this is due to, first, the prevailing industry culture (philanthropic, with an historic attitude of “collect what we can” and “a unit at any price”). Second, there is weak understanding of and incorporation of production control and supply chain management techniques in routine blood collection operations.

In the case of third party solutions, the systems do not work well because they were not designed for an enterprise-wide production control and supply chain solution. They were, instead, designed to be solutions for specific and discreet functional issues with blood banking (e.g., managing mobile drive sponsor accounts, inventory management).

The EPM System invention was designed as an enterprise-wide production control and supply chain management solution, linking and coordinating across the supply chain for an optimum collection solution to meet forecasted and dynamically shifting patient blood transfusion demand.

### The Version of The Invention Discussed Here Includes:

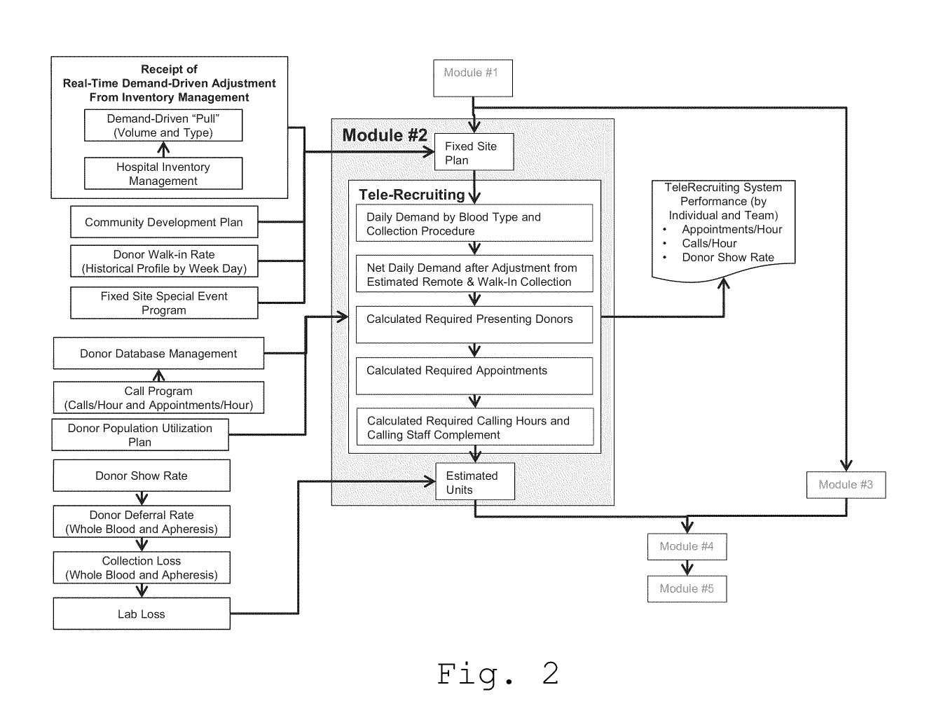

1. Develop (red blood cell) RBC Product Distribution Profile: “RBC Total Daily Goal” (annual calculation of the percentage of total blood unit distribution by day of the week from historical data records incorporating dynamic performance patterns, time-based shifts in patient usage.)
2. Develop (single donor platelet) SDP Product Distribution Profile: SDP “Total Daily Goal” (annual calculation of the percentage of total platelet unit distribution by day of the week from historical data records incorporating dynamic performance patterns, time-based shifts in patient usage.).)
3. Based on RBC and SDP Product Distribution Profiles, calculate Fixed Site and Mobile Ops Daily Goal (based on Fixed Site and Mobile collection allocation responsibility, and allowing for near-term, tactical change as required by blood demand dynamics, allowing for an aspect of production control “pull” system).
4. Assemble Collection Data Assumptions, including:
a) Donor walk-in rate (DWI) (historically determined non-appointment fixed site donations) (see #8),
Product distribution profile (by unit), RBC Total Daily Goal and SDP Total Daily Goal (see #1, #2),
c) Historical unit outdate rate (OR) (expiration), WB/RBC and SDP
d) Telerecruiting (TR) performance statistics, including: 1) calls/hour rate (C/H), 2) appointments/hour rate (NH), and 3) routine staff-hours per day (SH/D).
e) Lab performance statistics (loss rate).
f) RBC collection performance statistics, including: (1) RBC donor appointment show rate (SR), 2) Collection loss (e.g., QNS or quantity not sufficient, under or over volume), 3) Mobile Account Manager (AM) predictive accuracy (PA) (see #9),
g) SDP collection performance statistics, including 1) SDP donor appointment show rate (SR), 2) Apheresis collection loss (see #11), 3) Historical “split rate” (average SDP units per apheresis procedure) (see #12),
h) Donor deferral rate (DR) performance statistics for all collection modalities, (see #10).
5. For Telerecruiting Resource Alignment (see FIG. 2), Calculate “Average Daily TR Effort Demand by Blood Type” (volume collection goal by 1) day of the week, 2) by blood type for WB, RBC, and for 3) each of the apheresis procedures), showing (for each day):
a) Unit volume, total,
b) Unit volume, by fixed site,
c) Less the unit volume expected by donor walk-in rate (DWI),
d) Calculated telerecruiting unit volume requirement (TRUVR) (fixed site volume minus anticipated walk-in volume),
e) Calculated required presenting donors (PD) given 1) donor deferral rate (DR), 2) collection loss (CL), 3) lab loss (LL), and 4) unit outdate (expiration) rate (OR) in accordance with the following formula:

PD=TRUVR/[(1−DR)/(1−CL)/(1−LL)/(1−OR)]
f) Calculated required donor appointments (DA), given donor appointment show rate (SR), in accordance with the following formula:

DA=PD/SR
g. Calculated telerecruiting appointments requirement (APPT), given the telerecruiting appointments per hour statistics (see #4.d) for the following whole blood (WB) and apheresis (APH) procedure types, 1) WB “Whole Blood”, 2) APH01 “RBC+SDP”, 3) APH02 “2RBC”, 4) APH03 “RBC+SDP+Plasma”, 5) APH04 “RBC+2SDP”, 6) APH05 “RBC+2SDP+Plasma”, 7) APH06 RBC+3SDP”, 8) APH07 “2SDP+Plasma”, 9) APH08 “2SDP”, 10) APH09 “SDP”, 11) APH10 “RBC+Plasma”, 12) APH11 “SDP+Plasma”, 13) APH12 “3SDP”, 14) APH13 “3SDP+Plasma”, in accordance with the following formula:

APPT=DA/A/H
h. Calculated telerecruiting staffing requirement (STF), given the telerecruiting staff-hours per day (see #4.d), for all blood types and procedure types of #5.g above, in accordance with the following formula:

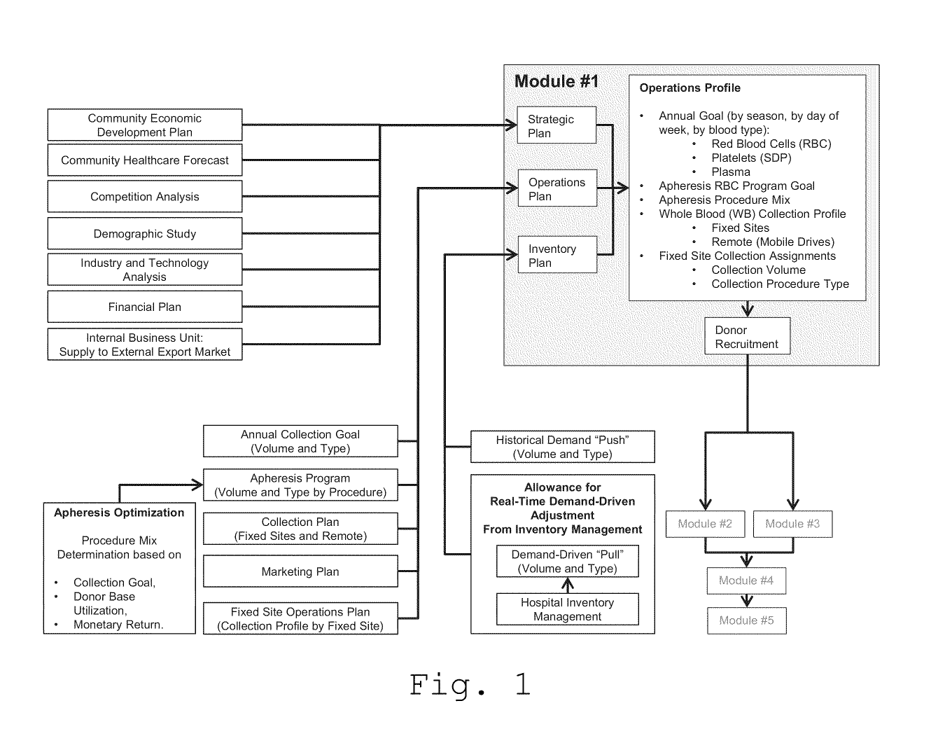

STF=APPT/SH/D
6. Develop the annual Apheresis Program Profile (see FIG. 1) (profile of the optimum procedure mix), based on targeted blood component collection volume (red blood cells, plasma, platelet) by apheresis procedure (e.g., see procedure mix #5.g.1-14 above), given
a) Annual total collection volume goal of: 1) Red blood cell (RBC) total collection volume and Apheresis-derived RBC percentage, 2) Apheresis plasma, 3) Single Donor Platelets (SDPs).
b) Annual marginal monetary contribution (following the formula: revenue−cost=profit) for each procedure type, maximizing financial return while ensuring adequate collection volume and optimum APH donor base utilization.
7. Develop the Collections Operations Profile by completing (see FIG. 1):
a) Strategic Plan, considering blood units needed given: 1) Historical demand (last one, two, and three years), 2) Community Economic Development Plan, 3) Community Healthcare Forecast, 4) Competition Analysis, 5) Demographic Study, 6) Industry & Technological Analysis, 7) Financial Plan, and 8) Internal Business Unit for Contract Export.
b) Operations Plan, consideration of “how” to collect the blood units given: 1) Annual Apheresis Program Profile, 2), Collection Plan, reflecting the volume and procedure for fixed site operation and mobile drive operation, 3) Annual volume and blood type collection goal (RBC, Plasma, SDP), and 4) Marketing Plan.
c) Inventory Plan, considering historical transfusion use pattern demand by blood type for 1) Whole blood, 2) RBC, and 3) SDP
8. Develop Historical Donor Walk-In Rate (DWI) (the non-appointment donations, calculated or captured in blood bank donor database) reflective of season, month and day of activity.
9. Develop Historical Account Manager Predictive Accuracy (PA), the ratio of actual collection volume and the predicted collection volume on mobile drives, in accordance with the formula:

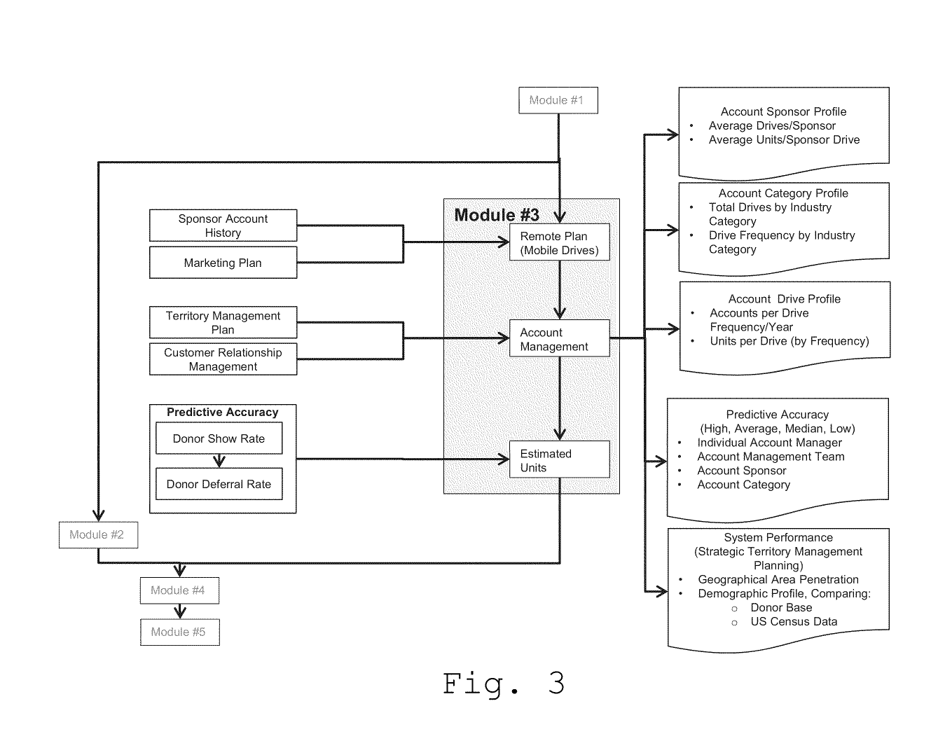

PA=Actual/Predicted
10. Develop Historical Donor Deferral Statistics (if deferral rate not recorded in blood bank system) for all collection modalities, including 1) Apheresis (APH) collections, 2) WB collections, and 3) differentiated by fixed site operation and each mobile operation type (e.g., 3-bed, 6-bed, inside setup)
11. Calculate the historical Apheresis (APH) Collection Loss Statistics (if Aph loss statistics not recorded in blood bank system)
12. Calculate the historical Apheresis (APH) “split rate” (Net units divided by the total number of APH procedures necessary to yield the units)
13. Develop the Fixed Site Donor Telerecruiting Plan (see FIG. 2) given
a) Historical donor walk-in rate (non-appointment donations),
b) Anticipated special fixed site events,
c) Community development plan,
d) Allowing for input of real-time demand-driven adjustments from inventory management.
14. Develop the Fixed Site Donor Telerecruiting System based on TR Work Load formula (#5 above), including historical:
a) Donor deferral rate,
b) Collection loss,
c) Lab losses,
d) Unit outdate (expiration) rate,
e) Donor appointment show rate,
f) Telerecruiter appointment per hour rate,
g) Telerecruiter calls per hour rate,
h) Establish how many appointments and calls per day required, ensure necessary staff to make calls.
15. Develop the Account Manager Plan (see FIG. 3) given
a) Sponsor account history,
b) Blood center marketing plan,
c) Territory management plan.
16. For Account Manager (AM) Resource Alignment and Account Manager System development, Calculate the “Average AM Effort Demand, showing:
a) Unit volume, total,
b) Unit volume, for AM team (TUV),
c) Targeted annual unit volume per AM (AMUV),
d) AM average predictive accuracy (PA) (expected collection volume divided by the actual collection volume), allowing for 1) Mobile drive donor show rate, and 2) Mobile drive donor deferral rate,
e) Calculating system requirements in accordance with the following formula:

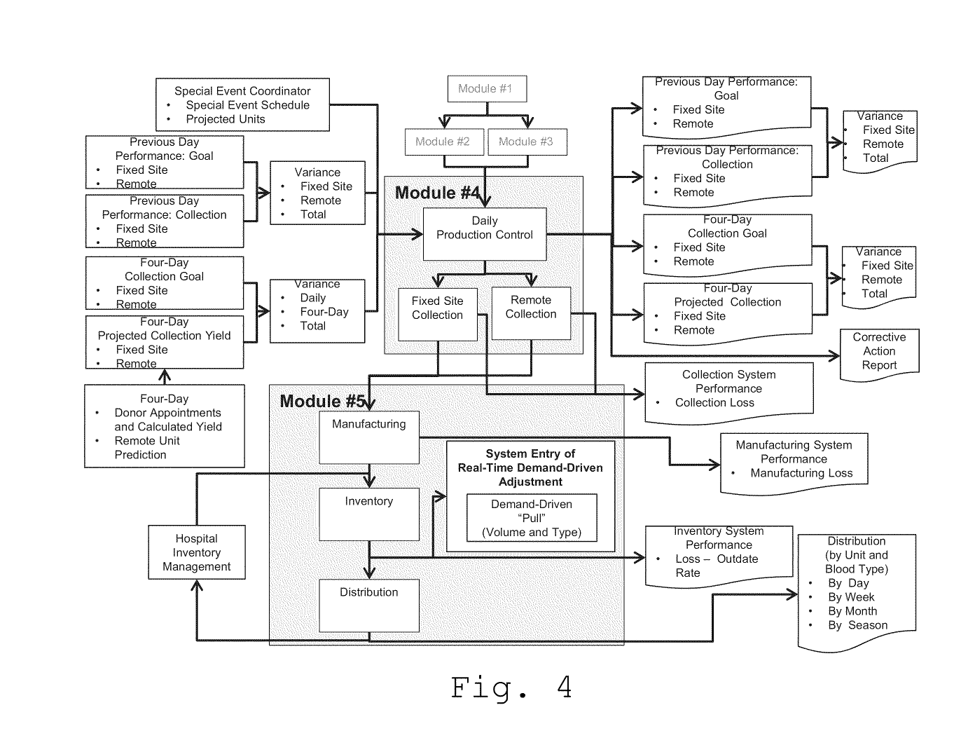

Total Number of AM=TUV/PA/AMUV
f) Establish sponsor account distribution scheme (e.g., geographic area or sponsor account type by targeted unit yield goal), assign Account Managers in accordance with scheme.
17. Telerecruiting operation, make donor calls (see #13, 14)
18. Account Manager establish mobile drives (see #15, 16)
19. For Daily-WB Production Control (see FIG. 4),
a) Enter the 1) predicted mobile drive and 2) actual collection for fixed site and mobile collection volume for the previous day (“Yesterday”),
b) Review the calculated collection goal, “Goal Performance” (see #1),
c) calculate the collection variance, “Goal Performance”, variance calculated in accordance with the following formula:

Variance=Goal−Actual Volume Collected
d) Note/record variance as necessary for contingency planning (e.g., make-up for too few collected units),
e) Enter the predicted mobile drive collection volume for the four-day period: Today, T+1, T+2, and T+3,
f) Calculate the units beside the “predicted” units, PU (a modification given Account Manager Predictive Accuracy, PA), in accordance with the following formula:

Calculated Units=PU/PA
g) Enter the “total scheduled appointments” (TSA) for the fixed site WB operations for the four-day period Today, T+1, T+2, and T+3
h) Calculate the Appointment Over-Under Quantity (AQ), calculated as follows:

Appointment Over-Under=TSA−DA(see #5.f)
i) Note/record the appointment quantity variance as necessary for contingency planning (e.g., make-up for too few appointments and, then, too few resulting units)
j) Calculate the “projected units” (PU) (given the donor appointment show rate, donor walk-in rate, projected donor deferrals, and collection loss), in accordance with the following formula:

PU=TSA×SR+DWI−DR−CL
Where TSA=Total Scheduled Appointments, SR=Donor Appointment Show Rate, DWI=Donor Non-Appointment Walk-In Rate, CL=Collection Losses
k) Compare and enter into contingency planning for mobile drives, fixed site operations, and “special drives” for the four-day period Today, T+1, T+2, and T+3. 1) If Goal Variance (Calculated Goal minus Projected Collection Volume) is zero or positive, do nothing 2) If Goal Variance (Calculated Goal minus Projected Collection Volume) is negative, execute contingency plans as necessary to collection the required volume of blood and blood products for the day (e.g., increase TR call volume, see 14.h).
20. For Daily-SDP Production Control (see FIG. 4),
a) Enter the 1) predicted mobile drive and 2) actual collection fixed site and mobile collection volume for the previous day (“Yesterday”),
b) Review the calculated collection goal, “Goal Performance” (see #2),
c) Calculate the collection variance, “Goal Performance”, variance calculated in accordance with the following formula:

Variance=Goal−Actual Volume Collected
d) Note/record variance as necessary for contingency planning (e.g., make-up for too few collected units),
e) Enter the predicted mobile drive collection volume for the four-day period: Today, T+1, T+2, and T+3,
f) Calculate the units beside the “predicted” units, PU (a modification given Account Manager Predictive Accuracy, PA), in accordance with the following formula:

Calculated Units=PU/PA
g) Enter the “total schedule appointments” (TSA) for the fixed site APH operations for the four-day period Today, T+1, T+2, and T+3,
h) Calculate the Appointment Over-Under appears, calculated as follows:

Appointment Over-Under=TSA−DA(see #5.f)
i) Note/record appointment variance as necessary for contingency planning (e.g., make-up for too few appointments and, then, too few resulting units),
j) Calculate the APH “projected units” (PU) (given the donor appointment show rate, donor walk-in rate, projected donor deferrals, and collection loss), in accordance with the following formula:

PU=TSA×SR+DWI−DR−CL
Where TSA=Total Scheduled Appointments, SR=Donor Appointment Show Rate, DWI=Donor Non-Appointment Walk-In Rate, CL=Collection Losses k) Compare and enter into contingency planning for APH operations mobile for the four-day period Today, T+1, T+2, and T+3. 1) If Goal Variance (Calculated Goal minus Projected Collection Volume) is zero or positive, do nothing 2) If Goal Variance (Calculated Goal minus Projected Collection Volume) is negative, execute contingency plans as necessary to collection the required volume of blood and blood products for the day (e.g., increase TR call volume, see 14.h).

### Relationship Between The Components:

Foundational preparation is in the form of building the Operations Profile (see FIG. 1) by integrating the strategic plan (step 7a), operations plan (step 7b), and inventory plan (step 7c). This is the “big picture” of the blood collection requirement; it is the coarse picture of the blood demand that the blood bank will be required to supply.

To adequately prepare for and ultimately collect the required total volume of blood and blood constituent products (RBC, SDP, Plasma) the blood bank will initially forecast the anticipated volume demand and daily distribution profile based on historical data, establishing historical demand/use performance patterns (i.e., developing a future demand profile (steps 1-3) based on historical dynamic patterns of supply distribution). This provides a comprehensive matrix view of anticipated blood demand by volume and by day (this is the core of the production control “push” system of this invention). Additionally, as means to productively address the near-term dynamic shifts in blood demand, the blood bank will allow for real-time changes to the donor recruitment, collection activity, inventory management, and product distribution, incorporating a production control “pull” system, including 1) a system allowance for real-time demand-driven adjustments (see FIG. 1, built into the Inventory plan and inventory management system), 2) system entry of real-time demand-driven adjustments (see FIG. 4, from Hospital Inventory Management upon demand change), 3) receipt of and response to real-time demand-driven adjustments in the donor telerecruiting system (see FIG. 2, from hospital-initiated inventory management system entry).

In that the ultimate net volume collected is a function of the unit prediction and the collection effort moderated and attenuated by system deficiencies and historical patterns of performance, preparation has to include assembly of necessary performance data for probability calculation (with a significant degree of confidence) (steps 4 a-h, 8, 9, 10, 11, and 12). The blood bank will calculate the probable net yield from the collected unit prediction. Plans and systems for donor recruitment will be established (steps 13 a-d, 14 a-h, 15 a-c, and 16 a-f). In accordance with the Operations Profile (step 7) and, specifically, the Collection Plan, (step 7.b.2) showing the assigned collection volume between the fixed site and mobile drive operations. These two operational modes will solicit donors to make blood donations reflective of their unique operations (fixed site by telerecruiting and mobile drives by managing mobile drive sponsor accounts).

The fixed site telerecruiters are facilitated in their effort by distinct calculations for each type of collection procedure (WB and all APH procedures), by day of the week, by blood type revealing net units required, necessary presenting donors, number of appointments required, required calls, required calling hours, and therefore the required calling staff (step #5). Cumulating all procedure types reveals the total telerecruiting staff (step 14) and, then, allows for hiring, team development, and shift assignments.

The mobile drive Account Managers are facilitated in their effort by distinct calculations for assigned collection unit yield goals (see #16).

These plans and systems, when put into action, requires the telerecruiters to call donors (step 17) and Account Managers to establish and manage sponsoring account mobile drives (step 18).

Production control (see FIG. 4) goes up to and includes the day of blood collection (steps #19, #20). First, the Daily Production Control allows for a critical review of the previous days collection yield (variation between goal and actual collection yield). This informs the subsequent review of the next four-day planned collection activity (allowing for construction and execution of contingency plans). Second, the Daily Production Control allows for a review of planned unit collection (and calculated probable unit yield) against goal for the four-day period Today, T+1, T+2, T+3), calculating a variance between daily goal and probable unit yield (again, allowing for contingency planning).

### How The Invention Works:

By following the above listed steps the blood bank can strategically plan for long-range blood demand, assemble necessary system performance data to make sound judgment on system development (resource alignment) and activity, and monitor and manage the blood collection reflective of actual blood demand.

The invention works in three distinct areas: system development and preparation, activity management, and production control.
1) With the calculation of probable net collection yield based on historical system performance patterns (for a “push” system) and the incorporation of a coordinating real-time demand-driven “pull” system the blood bank can develop systems to better produce a near “just-in-time” supply of blood (i.e., assemble and align an adequate level of resources, both human and equipment).
2) Activity management is facilitated by understanding of discrete work requirements (e.g., making enough donor telerecruiting calls, to make enough appointments, to ensure enough presenting donors, to yield the right volume of blood by type, by day, by specific collection procedure). It is only in this manner that the blood bank can efficiently establish collection processes, collected the right volume of the right type blood at the right time and, thereby, increase supply performance and reduce unit waste.
3) Production control is facilitated by the assembly of, review of, and action on all necessary performance measures into a single source report allowing high confidence in demand-driven collection.

In the Daily Production Control, if the predicted collection yield matches the unit goal, then the collection activity can proceed as planned. However, if the review of prediction and goal reveals a variance, contingency plans will have to be executed to modify the predicted units for closer reflection of goal.

### How To Make The Invention:

The means to make the invention are contained in the above steps. It is the systematic collection of system performance data, utilization in probably yield calculations, with review of and action on system performance pattern shifts that allows for near “just-in-time” blood collection and distribution for patient transfusion. This can be accomplished in a number of systems, including MS Excel™ (in which the prototype was constructed).

### How To Use The Invention:

By systematically following the above listed steps, blood bank personnel can analytically examine collection activity in respect to demand and, thereby, establish, operate, management, and review a demand-driven blood bank enterprise planning and management system.

Additionally: Initially developed with MS Excel™ spreadsheet format, this invention can be converted to a computer program.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for optimizing collection and usage of a necessary bodily fluid, comprising:
determining an historical demand of the bodily fluid;
measuring a first external contingent factor;
creating a donor recruitment plan based at least in part on the historical demand and the external contingent factor;
implementing the donor recruitment plan to recruit a number of donors;
determining estimated units based at least in part on the number of donors and a second external contingent factor;
collecting total units of the necessary bodily fluid; and
calculating a variance between the total units and the estimated units to produce a real-time demand driven adjustment.

2. The method as claimed in claim 1, wherein the donor recruitment plan comprises a fixed site plan and the step of determining estimated units depends at least in part on the real-time demand driven adjustment.

3. The method as claimed in claim 1, wherein the donor recruitment plan comprises a mobile site plan and the step of determining estimated units depends at least in part on a donor show rate.

4. The method as claimed in claim 1, wherein the donor recruitment plan comprises a mobile site plan and the step of determining estimated units depends at least in part on a donor deferral rate.

5. The method as claimed in claim 1, wherein the first external contingent factor comprises a community economic development plan.

6. The method as claimed in claim 1, wherein the first external contingent factor comprises a community healthcare forecast.

7. The method as claimed in claim 1, wherein the first external contingent factor comprises a demographic study.

8. The method as claimed in claim 1, wherein the second external contingent factor comprises a donor walk-in historical profile by week day.

9. The method as claimed in claim 1, wherein the second external contingent factor comprises a donor show rate.

10. The method as claimed in claim 1, wherein the second external contingent factor comprises a donor deferral rate.

11. The method as claimed in claim 1, wherein the second external contingent factor comprises a collection loss.

12. The method as claimed in claim 1, wherein the second external contingent factor comprises a lab loss.

13. A method for optimizing collection and usage of a necessary bodily fluid, comprising:
a) determining an historical demand of the bodily fluid;
b) measuring a first external contingent factor;
c) determining real-time changes to the historical demand;
d) creating a fixed donor recruitment plan and a mobile donor recruitment plan based at least in part on the historical demand, the external contingent factor, and the real-time changes to the historical demand;
e) implementing the fixed donor recruitment plan to recruit a fixed number of donors;
f) determining estimated fixed units based at least in part on the fixed number of donors and a second external contingent factor;
g) implementing the mobile donor recruitment plan to recruit a mobile number of donors;
h) determining estimated mobile units based at least in part on the mobile number of donors and a third external contingent factor;
i) collecting total units of the necessary bodily fluid; and
j) calculating a variance between the total units, the estimated fixed units, and the estimated mobile units to produce a first real-time demand-driven adjustment.

14. The method as claimed in claim 13, further comprising the steps of:
k) monitoring actual real-time demand;
l) calculating a second variance between total units and the actual real-time demand to produce a second real-time demand-driven adjustment; and
m) feeding back the first and second real-time demand-driven adjustments into step d) so that the step of creating in step d) depends at least in part on the first and second real-time demand-driven adjustments.
